(19) United States
(12) Patent Application Publication
(10) Pub. No.: US 2010/0226289 A1
(43) Pub. Date: Sep. 9, 2010

(54) FLOOR CONTROL IN TELECOMMUNICATIONS CONFERENCE CALLS

(76) Inventor: Jouni Mäenpää, Nummela (FI)

Correspondence Address: ERICSSON INC., 6300 LEGACY DRIVE, M/S EVR 1-C-11, PLANO, TX, 75024, US

(21) Appl. No.: 12/682,168

(22) PCT Filed: Oct. 8, 2007
(86) PCT No.: PCT/EP07/60635

§ 371 Date: Apr. 8, 2010

(51) Int. Cl. H04L 12/16; H04L 12/66

(52) U.S. Cl. 370/260; 370/352

(57) ABSTRACT

A method of enabling a user terminal to participate in floor control operations in a telecommunications conference operating a Binary Floor Control Protocol, BFCP. The method includes sending a first message from the user terminal to a gateway node. The first message includes information relating to floor control operations in the conference. The first message is inter-worked at the gateway node to generate a corresponding BFCP message. The BFCP message is forwarded to a Floor Control function.

### TECHNICAL FIELD

The present invention relates to methods and equipment for use in telecommunications conference calls. More particularly, the invention relates to telecommunications conference calls that are provided for users of Circuit Switched (CS) networks but are hosted in a Packet Switched (PS) network, for example the Internet Protocol Multimedia Subsystem (IMS), and vice versa.

### BACKGROUND

The IP Multimedia Subsystem (IMS) is the technology defined by the Third Generation Partnership Project (3GPP) to provide IP Multimedia services over mobile communication networks. IP Multimedia services provide a dynamic combination of voice, video, messaging, data, etc. within the same session. As the number of basic applications, and the media which it is possible to combine, increases, so will the number of services offered to the end users, giving rise to a new generation of personalised, rich multimedia communication services.

FIG. 1 illustrates schematically how the IMS fits into the mobile network architecture. In the case of a General Packet Radio Service (GPRS) packet switched (PS) domain 1, user terminals access the network via a network of GPRS Support Nodes (GSNs). A gateway GPRS support node (GGSN) 2 acts as an interface between the GPRS backbone network and other networks (radio networks and the IMS 3). Users can also access the IMS via a CS access network through the CS domain 4, where the signal flows are controlled by a network of Mobile Switching Centre (MSC) servers 6. A media gateway (MG or MGW) 8b, controlled by a Media Gateway Control Function (MGC or MGCF) 8a, acts as the interface between the CS domain 4 and PS networks such as the PS domain 1 as well as the IMS 3.

The IMS 3 includes a core network 3a and a Service Network 3b. The IMS core network 3a includes nodes that send/receive signals to/from the GGSN 2 and network nodes that include Call/Session Control Functions (CSCFs) 5.

The IMS service network 3b includes Application Servers (ASs) 7 for implementing IMS service functionality. Application Servers 7 provide services to end-users, and may be connected either as end-points, or “linked in” between the session peers.

The IMS architecture makes it possible to deploy peer-to-peer applications where two or more users exchange data during a SIP session. Examples of such peer-to-peer applications include Multimedia Telephony (MMTel), Push to Talk over Cellular (PoC), streaming, real-time video sharing, file sharing, gaming etc. The transport connection(s) is (are) negotiated dynamically by means of the SIP/SDP protocol exchange between the two end points (user terminals).

However, PS networks such as the IMS also enable sessions involving more than two user terminals communicating and sharing data in a conference session. Conferencing within the IMS is coordinated by a Serving-CSCF (S-CSCF) 5, in conjunction with an Application Server 7. The mixing of the various conference participants' media streams is then performed by a Media Resource Function (MRF), which includes a Media Resource Function Controller (MRFC) and a Media Resource Function Processor (MRFP) 9. The MRFP 9 mixes media streams based on instructions from the MRFC, and also translates (transcodes) streams, if inter-working is required.

According to the current 3GPP specifications, in 3GPP release 7 conference sessions hosted by the IMS involve the use of floor control, which is a means to manage joint or exclusive access to shared resources in a multiparty conferencing environment. A floor is a temporary permission to access or manipulate a specific shared resource or a set of resources. The protocol used for floor control signalling is the Binary Floor Control Protocol (BFCP) [3GPP TS 24.147]. BFCP has been specified by the Internet Engineering Task Force (IETF) in RFC 4582. As well as the IMS, other PS networks may also provide conference facilities using BFCP.

In a floor-controlled audio conference, a floor is associated with the audio stream, and the participant holding the floor has the permission to send media over the audio stream (that is, the participant has the permission to speak). In a floor-controlled multimedia conference consisting of audio and video media components, the floor holder has the right to send media over the audio and video streams. In general, only one participant is permitted to hold the floor at any one time, and this is of significant benefit in preventing potentially confusing situations when two or more participants try to communicate at the same time using the same media component.

A participant in the conference sends a BFCP request to hold a floor (i.e. to be given access to a particular media resource) to a floor control server (FCS) controlling that media resource (e.g. in a floor-controlled audio conference, a user can request the permission to speak by sending a BFCP floor control request to the FCS controlling the audio stream). The FCS grants or denies the request by means of BFCP signalling. The

FCS is a logical entity that maintains the state of the floor. According to the current 3GPP specifications, in 3GPP release 7, the FCS is located in the MRFP 9, although it could also be located in another node, for example an Application Server (AS) 7.

In addition, a floor chair manages the floors. Each floor chair is a logical entity that manages one floor, and may be one of the participants in the conference. The floor chair can send decisions regarding floor requests to the FCS using BFCP signalling. Also, BFCP provides the means for the FCS to keep participants and floor chairs informed about the status of a given floor or a given floor request.

Mobile Circuit Switched (CS) services based on GSM and WCDMA radio access are a world-wide success story and have allowed telecommunication services to be provided to subscribers in almost all countries of the world. Also, the number of subscribers to networks that provide CS services is still growing rapidly. However, BFCP is a rather new protocol (RFC published in November 2006) used in PS networks and is not supported by CS network terminals. If a user located in a CS network joins a floor-controlled conference hosted in a PS network, such as the IMS, the user has no means to request the floor. This means that the CS user can never request permission to speak in the conference. If floor control is enforced in the conference any media sent by the CS user is not forwarded to the other participants because the user is not holding the floor. Thus, the CS user is limited to being a listen-only participant and can never be heard (in an audio conference) by the other participants. If floor control is not enforced, the CS user can get his voice through, but only because the floor control decisions are not being enforced. However, this removes the benefits of floor control from the viewpoint of the other BFCP-enabled participants. Floor control only works if all the participants obey the decisions made by the floor chair. The only way for CS users to obey the decisions made by the floor chair is not to send media at all (since they can never gain the permission to do so).

Also, for example, H.323 terminals do not support BFCP. H.323 (as defined by International Telecommunication Union—Telecommunications Standardization Sector in ITU-T H.323) is an umbrella recommendation from ITU-T, and it defines protocols to provide audio-visual communication session on any PS network. H.323 is commonly used in Voice over IP (VoIP) and IP-based videoconferencing. Also, some CS user terminals may use the H.245 control protocol (defined by ITU-T H.245), which provides, among other things, a RequestForFloor conference indication, but this is not the same as the BFCP Floor Request, which is not supported. In addition to CS users, there may also be IP-enabled terminals that do not support BFCP present in a conference hosted in the IMS. This is because 3GPP does not mandate BFCP support for IMS terminals (see 3GPP TS 24.147).

The present invention has been conceived with the foregoing in mind.

### SUMMARY

According to a first aspect of the present invention there is provided a method of enabling a user terminal to participate in floor control operations in a telecommunications conference operating a Binary Floor Control Protocol, BFCP, the method comprising: sending a first message from the user terminal to a gateway node, wherein the first message comprises information relating to floor control operations in the conference; inter-working the first message received at the gateway node to generate a corresponding BFCP message; and forwarding the BFCP message to a Floor Control function.

It is an advantage of the present invention that, by inter-working the first message to generate a corresponding BFCP message, a user terminal (for example a CS terminal) that is not configured for BFCP messages can participate in floor control activities in the conference.

In embodiments of the invention, the first message is a Dual Tone Multi Frequency, DTMF, message. The first message may be one of a set of messages relating to floor control operations. The set of messages may comprise a Floor Request message and a Floor Release message.

Embodiments of the invention may include, prior to the step of sending a first message, sending a request from said user terminal to the gateway node indicating a desire to participate in Floor Control operations. A reply may be sent to the user terminal in response to the request, the reply including a menu of options for requesting floor control operations. The reply may comprise an Announcement.

Embodiments of the invention may further comprise sending a response to the first message to the gateway node, the response comprising either a BFCP Floor Request Status message, or an Error message. The Floor Request Status message may include an indication either that the floor request is pending, or that it has been granted or that it has been denied. Embodiments may further comprise inter-working the response to generate an announcement and sending the announcement to the user terminal. The announcement may comprise information indicating that the user has been granted the floor, or information indicating that the user has been denied the floor, or information that an error has arisen.

In embodiments of the invention the gateway node is a gateway between a circuit-switched, CS, 3G-324M network and an IMS network, and the first message comprises a H.245 control protocol conference indication. The first message may comprise a H.245 RequestForFloor conference indication and the step of inter-working the first message may comprise generating a BFCP FloorRequest message.

Embodiments of the invention may further comprise sending a BFCP FloorRequestStatus message from the Floor Control function to the gateway node. The FloorRequestStatus message may have a status “granted” when the floor has been granted to the user.

In embodiments of the invention, wherein the floor requested includes video media, the gateway node may send a H.245 seenByAtLeastOneOther conference indication to the 3G-324M terminal. Where the floor is an audio conference floor, the gateway node may use voice activity detection to determine when the user has finished speaking, to generate a BFCP FloorRelease message, and to send the BFCP FloorRelease message to the Floor Control function after the user has finished.

In embodiments of the invention the BFCP messages that are inter-worked may include one or more of FloorRequest, FloorRelease, FloorRequestStatus and Error messages. The BFCP messages that are inter-worked may further include one or more of the messages that are marked as ‘Optional’ in Tables 1 and 2 below.

According to a second aspect of the present invention there is provided a method for a user terminal to participate in floor control operations in a telecommunications conference provided by a circuit-switched, CS, network, wherein the user terminal provides floor control signalling using a Binary Floor Control Protocol, BFCP, the method comprising: sending a first BFCP message from the user terminal to a gateway node, wherein the first BFCP message comprises information relating to floor control operations in the conference; inter-working the first BFCP message received at the gateway node to generate a corresponding floor control message; and forwarding the floor control message to the CS network.

According to a third aspect of the present invention there is provided a system for enabling a user terminal to participate in floor control operations in a telecommunications conference operating a Binary Floor Control Protocol, BFCP, the system comprising a gateway node and a Floor Control Server (FCS), wherein the gateway node is configured to receive a first message from a user terminal, the first message comprising information relating to floor control operations in the conference, to inter-work the first message so as to generate a corresponding BFCP message, and to forward the BFCP message to the floor control server.

The gateway node may comprise a gateway between a circuit-switched and a packet-switched network. The gateway node comprises a Media Gateway Control Function, MGCF. The gateway node may comprise a Media Gateway, MGW, and a Media Gateway Controller, MGC. The gateway node may comprise an IMS Media Gateway, IM-MGW.

In embodiments of the invention the FCS is located in a Media Resource Function Processor, MRFP, or in an Application Server, AS.

According to a fourth aspect of the present invention there is provided a gateway function controlling a gateway that provides an interface between a circuit-switched, CS, network and a packet-switched, PS, network, the gateway function comprising: means for receiving a floor control request message from a user terminal, the floor control request message comprising information relating to a conference operating a Binary Floor Control Protocol, BFCP; means for inter-working the floor control request message received at the gateway function to generate a corresponding BFCP message; and means for forwarding the BFCP message to a Floor Control function in the PS network.

According to a fifth aspect of the present invention there is provided a gateway function controlling a gateway that provides an interface between a circuit switched, CS network and a packet switched, PS, network, the gateway function comprising: means for receiving a Binary Floor Control Protocol, BFCP, message from a user terminal, the BFCP message comprising information relating to floor control operations in a conference session provided by the CS network; means for inter-working the BFCP message so as to generate a corresponding floor control message; and means for forwarding the corresponding floor control message to the CS network.

### BRIEF DESCRIPTION OF THE DRAWINGS

Embodiments of the invention are described below with reference to the drawings, in which:

FIG. 1 is a schematic illustration of a GPRS/PS access network showing how the IMS fits into the mobile network architecture.

FIG. 2 is schematic illustration showing the signalling steps in a procedure according to a first embodiment.

FIG. 3 is schematic illustration showing the signalling steps in a procedure according to another embodiment.

### DETAILED DESCRIPTION

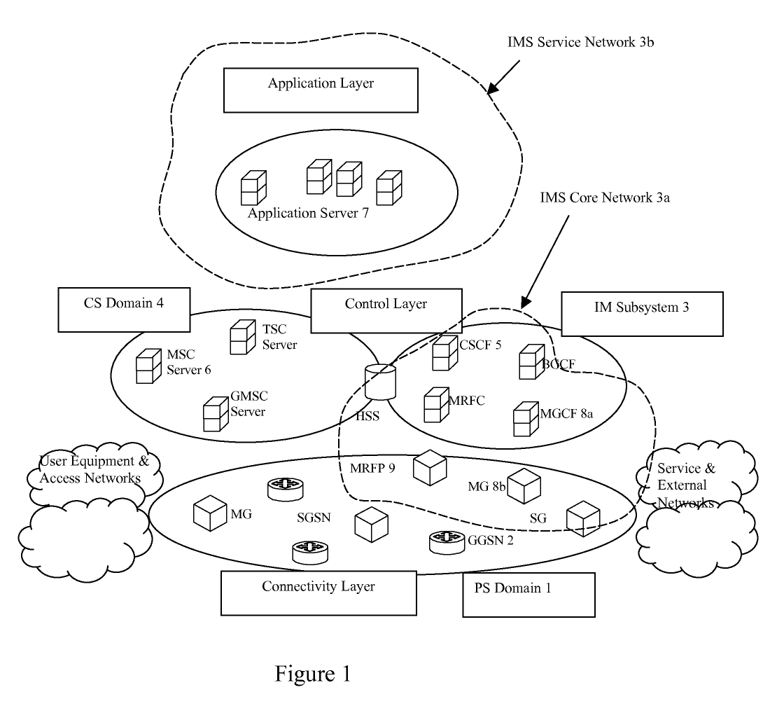

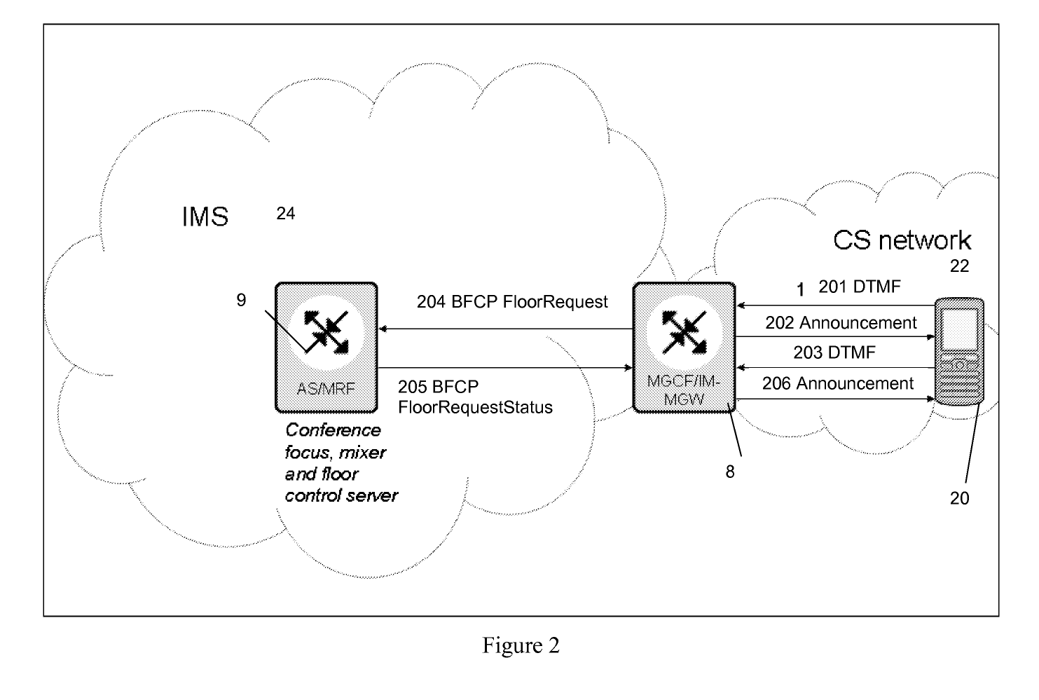

The basic principle, according to a first embodiment of the invention, for enabling a CS terminal to request the floor in a conference hosted in a PS network and using BFCP is shown in FIG. 2. The equivalent network entities have the same reference numerals as shown in FIG. 1. In the embodiment of FIG. 2, the IMS is used as an example of a PS network. However, the principles of this invention may be applied with any PS network using BFCP for conference floor control.

At step 201, a CS user participating in a conference (i.e. the user has already registered or logged into the conference) sends a special sequence of Dual Tone Multi-Frequency (DTMF) digits to a CS/PS gateway node sitting between a CS network 22 and a PS network (IMS) 24 by entering the digits using the keypad of his terminal 20. In the present example, and referring again to FIG. 1 for the case where the PS network is the IMS 3, the CS/PS gateway node is a Media Gateway Control Function (MGCF) 8a controlling a Media Gateway (MG) 8b, which is an IMS Media Gateway (IM-MGW). For simplicity hereafter this will be referred to as the MGCF 8, although it should not be forgotten that the gateway and the control function processing may take place in physically separate units, or that the principles may be applied to any CS/PS gateway function. The special sequence of DTMF digits indicates to the MGCF 8 that the CS user wishes to carry out floor control operations. Accordingly, CS users can request and release a floor by sending Dual Tone Multi-Frequency (DTMF) digits from their terminals. Also non-BFCP-capable PS users can use DTMF for floor control.

The MGCF 8 (or other CS/PS gateway node) inter-works the DTMF digits from the terminal 20 to BFCP messages. In the other direction, the MGCF 8 inter-works the BFCP messages from the floor control server located in the PS network (IMS 24) and sends these to the CS network 22 by using announcements.

At step 202, the MGCF 8 sends an announcement containing an audio menu to the CS user's terminal 20. The audio menu comprises various options including: 1. “Request the floor”; 2. “Release the floor”.

At step 203, the user enters the DTMF digit or digits corresponding to the action he/she wishes to perform. If the action is to request the floor, when the MGCF 8 receives the DTMF digit or digits, it translates, or “inter-works” this information by generating an equivalent BFCP FloorRequest message, and at step 204 sends a BFCP FloorRequest message to the FCS, which, in this example is located in the MRFP 9, or in an Application Server (AS). In practice, as explained above, the MGCF 8 comprises a Media Gateway (MG), which is controlled by a Media Gateway Controller (MGC). These may be integrated or physically separate units, in which case the DTMF digits would be reported by the MGW to the MGC (for example, using the H.248 gateway control protocol). The MGC would then order the MGW to send an appropriate BFCP message (if the MGC and MGW are separate units, this would again happen via H.248). The mapping from DTMF digits to BFCP messages would be specified in software in the MGC.

At step 205, the FCS responds to the FloorRequest message with a BFCP FloorRequestStatus message, which provides information about the status of the floor request. The FloorRequestStatus message can indicate among other things that the floor request is pending or that it has been granted or denied.

Once the MGCF 8 receives the FloorRequestStatus message, it inter-works (generates) an announcement indicating the status of the floor control request and sends this to the CS terminal 20 at step 206. Depending on the content of the FloorRequestStatus message, the announcement might contain the following information: “You have been granted the floor”, or “You have been denied the floor”.

DTMF messages can be used in existing (video) conferencing, but not for IMS conferences using BFCP. For example, users can send DTMF messages to the gateway to control the layout of the video sent to the user. In this embodiment of the invention, the same DTMF messages are used by the CS user. These are sent to the MGCF 8 and are inter-worked to generate BFCP floor control messages on behalf of the CS user.

Most, if not all CS terminals do not support advanced IMS conferencing features such as data conferencing (e.g. conference whiteboards) or Message Session Relay Protocol (MSRP) conferences with file sharing. This means that the CS users participating in an IMS conference will normally use only one floor in any conference—the floor associated with an audio stream or with an audio and a video stream. If the conference has an additional floor, for instance one associated with a shared conference whiteboard, the CS user cannot make use of that floor because the CS user has no means to write or draw to the shared whiteboard. The MGCF 8, which provides the BFCP signalling to the IMS, hides any additional floor or floors from the CS user.

The BFCP messages that can be inter-worked between the CS network and the IMS are described in Table 1. The minimum set of BFCP messages that must to be inter-worked to enable a CS user to hold a floor in an IMS conference are marked with the label ‘Required’ in the ‘Inter-working’ column. These include FloorRequest, FloorRelease, FloorRequestStatus and Error messages. The purpose of these messages is described in Table 1. The messages that can enhance the user experience, but whose inter-working is not mandatory are marked as ‘Optional’. Finally, messages that can be terminated or initiated by the MGCF 8, but which do not need to be inter-worked are marked as ‘No inter-working needed’ in the ‘Inter-working’ column of Table 1.

TABLE 1
Inter-working of BFCP messages

| BFCP | | Inter- | | Implementation of |
|---|---|---|---|---|
| Message | Purpose [RFC 4582] | working | Direction | Interworking |
| FloorRequest | Floor participants can request a | Required | CS → IMS | DTMF from CS terminal |
| | floor by sending a | | | triggers the MGW to send a |
| | FloorRequest message to the | | | FloorRequest message to the |
| | floor control server (FCS). | | | FCS. |
| FloorRelease | Floor participants can release a | Required | CS → IMS | DTMF from a CS terminal |
| | floor by sending a | | | triggers the MGW to send a |
| | FloorRelease message to the | | | FloorRelease message to the |
| | FCS. | | | FCS. |
| FloorRequestStatus | The FCS can inform floor | Required | IMS → CS | A FloorRequestStatus |
| | participants and floor chairs | | | message received from the |
| | about the status of their floor | | | FCS triggers the MGW to |
| | requests by sending them | | | send an announcement in to |
| | FloorRequestStatus messages. | | | the CS terminal. |
| Error | Floor control servers can | Required | IMS → CS | An Error message received |
| | inform floor participants and | | | from the FCS triggers the |
| | floor chairs about errors that | | | MGW to send an |
| | occur while processing requests | | | announcement towards the |
| | by sending them Error | | | CS terminal to indicate that |
| | messages. | | | an error has occurred. |
| FloorRequestQuery | Floor participants and floor | Optional | CS → IMS | DTMF from the CS terminal |
| | chairs can request information | | | triggers the MGW to send a |
| | about the status of a particular | | | FloorRequestQuery message |
| | floor request by sending a | | | for the most recent floor |
| | FloorRequestQuery message to | | | request initiated by the CS |
| | the FCS. | | | user. |
| Hello | Floor participants and floor | No inter- | CS → IMS | There is no need for the CS |
| | chairs can check if the floor | working | | user to check if the FCS is |
| | control servers are active by | needed | | active. This task can be done |
| | sending a Hello message. The | | | by the MGW on behalf of the |
| | Hello message can also be used | | | user. |
| | to obtain the capabilities of a | | | |
| | floor control server. | | | |
| HelloAck | Floor control servers confirm | No inter- | IMS → CS | There is no need for the |
| | that they are active on reception | working | | MGW to forward HelloAck |
| | of a Hello message by sending | needed | | messages to the CS side, |
| | a HelloAck message. | | | since the Hello messages are |
| | | | | sent by the MGW on behalf |
| | | | | of the user. |
| FloorStatus | The FCS can inform floor | Optional | IMS → CS | A FloorStatus message |
| | participants and floor chairs | | | received from the FCS |
| | about the status of a floor (e.g. | | | triggers the MGW to send an |
| | the current holder of the floor) | | | announcement towards the |
| | by sending them FloorStatus | | | CS user. Only the |
| | messages. The first FloorStatus | | | information about the status |
| | message is sent as a response to | | | of the floor (free, reserved, |
| | the FloorQuery message. After | | | etc.) is included in the |
| | this, the FCS will send | | | announcement. However, if |
| | subsequent FloorStatus | | | the MGW has text-to-speech |
| | messages periodically, | | | (TTS) capabilities, there is |
| | informing the client about | | | the option to include |
| | changes to the floors the client | | | additional information. |
| | requested information about. If | | | |
| | a client no longer wishes to | | | |
| | receive periodic FloorStatus | | | |
| | messages, it sends a new | | | |
| | FloorQuery message. | | | |

Table 2 lists BFCP messages that can only be inter-worked for CS networks with support for advanced features such as Text-To-Speech (TTS) in the MGCF 8. Basic floor control functionality requires only the inter-working of the messages marked as ‘Required’ in Table 1.

TABLE 2
Messages whose inter-working requires advanced capabilities from the
MGFC

| BFCP Message | Purpose [RFC 4582] | Interworking | Direction |
|---|---|---|---|
| UserQuery | Floor participants and floor chairs can request | Optional | Participant → FCS |
| | information about a participant, such as the | | |
| | display name and the URI of a particular floor | | |
| | participant, and the floor requests related to this | | |
| | participant by sending a UserQuery message to | | |
| | the FCS. | | |
| UserStatus | The FCS can provide information about | Optional | FCS → participant |
| | participants and their related floor requests to | | |
| | floor participants and floor chairs by sending | | |
| | them UserStatus messages. | | |
| ChairAction | Floor chairs can send instructions to floor | Optional | Participant → FCS |
| | control servers by sending ChairAction | | |
| | messages. If a floor request has contained | | |
| | requests for two floors that depend on different | | |
| | floor chairs, the FCS needs to wait for | | |
| | ChairAction messages from both of the chairs | | |
| | before it can grant or deny the floor. | | |
| ChairActionAck | Floor control servers confirm that they have | Optional | FCS → participant |
| | accepted a ChairAction message by sending a | | |
| | ChairActionAck message. | | |

All of the messages of Table 2 are either user-initiated messages or responses thereto, and are used to provide additional services to the user. The MGCF 8 may choose, or be configured, not to provide the CS participant with the facility to send the messages of Table 2 (i.e. the audio menu the MGCF 8 provides to the CS user at step 202 of FIG. 2 does not contain options such as “user query” and “chair action”). In that case the MGCF 8 will never need to send “UserQuery” and “ChairAction” requests and it will also never receive “UserStatus” and “ChairActionAck” replies from the IMS (since these replies are triggered by “UserQuery” and “ChairAction” requests). The messages of Table 2 are not required when providing basic floor control services, they are only needed to provide advanced floor control services such as the possibility to act as a floor chair. Thus, inter-working is required for these messages only if the MGCF 8 offers the user the facility to send these messages in the first place. The messages of Table 2 can be grouped into the following two categories: user information query and response, and messages needed in floor chair operations. If these messages are not inter-worked, the only impact is that the CS users cannot send queries to get information about other users (e.g. the name of the user), and cannot act as the floor chair.

It should not be forgotten that floor control is optional for IMS terminals (see 3GPP TS 24.147). Therefore, it is possible that an IMS terminal participating in an IMS conference does not support BFCP. The inter-working procedure described above can also be used to provide floor control functionality for these terminals. In this case the gateway in which the inter-working is implemented is the GGSN 2 (see FIG. 1).

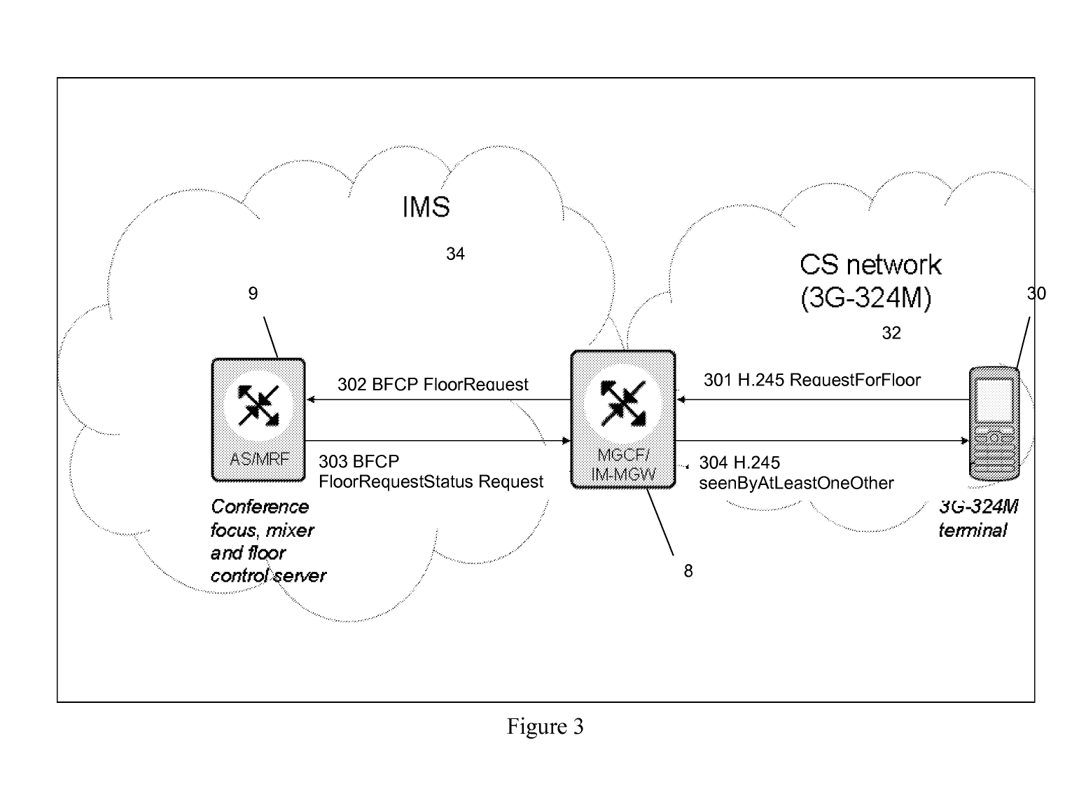

Another embodiment of the invention is described with reference to FIG. 3. This embodiment provides a way for the gateway node, MGCF 8, sitting between a CS 3G-324M network 32 and an IMS network 34, to offer a 3G-324M terminal 30 the ability to request the floor in a floor-controlled conference hosted in the IMS 3. 3G-324M terminals use the H.245 control protocol (as defined by International Telecommunication Union - Telecommunications Standardization Sector in ITU-T H.245). H.245 is a control protocol for multimedia communication and it describes the messages and procedures for opening and closing logical channels for audio, video and data, as well as providing for capability exchange and indications. H.245 provides end-to-end control signalling for operation of a 3G-324M terminal. H.245 also defines certain conference indications, including a RequestForFloor. In a conference provided in the CS network, this is sent from a terminal to a Multipoint Control Unit (MCU) to request a floor. H.245 also defines a FloorRequested conference indication, which is sent from the MCU to the chair token holder (i.e. the floor chair). These two indications are sent as H.230 (ITU-T H.230) Terminal Indicate Floor-request (TIF) symbols.

This embodiment of the invention provides for the MGCF 8 to inter-work the H.245 RequestForFloor conference indication to a BFCP FloorRequest message. In H.245, a terminal's capability set, which specifies the total capability of a terminal to receive and decode various signals, is made known to the other endpoint. Thus, the MGCF 8 can learn whether the terminal 30 supports conference capabilities through the exchange of H.245 terminal capability sets. If the 3G-324M terminal 30 has indicated that it supports the H.245 ConferenceCapability, the MGCF 8 knows that the terminal 30 is capable of sending H.245 RequestForFloor conference indications.

As shown in FIG. 3, at step 301, the 3G-324M terminal 30 sends a H.245 RequestForFloor conference indication (which corresponds to a H.230 TIF symbol) to the MGCF 8. The MGCF 8 inter-works the TIF to a BFCP FloorRequest, and at step 302 this is sent to the FCS in the MRFP 9 (or an AS) in the IMS 3.

At step 303, the FCS sends a BFCP FloorRequestStatus message with status ‘granted’ to the MGCF 8. Before this, the FCS may have sent BFCP FloorRequestStatus messages with other status values, but because H.245 does not support such messages, these are not inter-worked by the MGCF 8, and so are not sent to the CS network 32. However, announcements could be used to provide such status information to the 3G-324M terminal 30, as described above for the first embodiment.

If the floor media includes video, then after receiving the FloorRequestStatus message with status ‘granted’, at step 304 the MGCF 8 sends a H.245 seenByAtLeastOneOther conference indication (also known as H.230 Multipoint Indication Visualization (MIV)) to the 3G-324M terminal 30. This indicates to the terminal that its video signal is being seen by at least one other terminal, meaning that the terminal has been granted the floor in the conference. In an audio-only conference the MGCF sends an announcement (e.g. “You have been granted the floor”) to the 3G-324M terminal, as was explained in step 206 of FIG. 1.

Floor control in H.245 is limited to the RequestForFloor and FloorRequested conference indications. This means that BFCP messages other than FloorRequest and FloorRequestStatus with status ‘granted’ cannot be inter-worked to H.245. However, additional floor control functionality can be provided to the 3G-324M terminal 30 using DTMF and announcements as described above for the first embodiment.

In an IMS conference using BFCP, users are expected to release the floor when they stop (e.g when the finish speaking in an audio floor). However, in H.245 the human floor chair is expected to determine when it is appropriate to grant the floor to the next user, and does not require an explicit indication from the current floor holder that he has finished. Thus, in the IMS conference, the MGCF 8 will not receive an explicit indication from 3G-324M terminal 30 that it has finished, but it will need to generate a BFCP FloorRelease message after the 3G-324M user has finished. For an audio conference floor, the MGCF 8 can use voice activity detection; a BFCP FloorRelease message is sent to the FCS as soon as it is detected that the CS user has become silent. Alternatively, the user could send a DTMF message to indicate that the floor can be released, as was described above for the first embodiment.

In the scenario described above, a 3G-324M user terminal 30 is participating in a floor-controlled conference in a PS network (e.g. the IMS 34). However, it is also possible that an IMS user could be participating in a floor-controlled 3G-324M conference implemented using an MCU. In that case the same principles can be applied in reverse. The gateway sitting between the IMS (or other PS network) and the 3G-324M network can provide floor control inter-working from BFCP to H.245 for the PS user. Thus, the gateway inter-works a BFCP FloorRequest message to generate a H.245 FloorRequested conference indication, and interworks a H.245 seenByAtLeastOneOther conference indication to generate a BFCP FloorRequestStatus messages with status ‘granted’.

Since the H.245 control protocol is also used in H.323 networks (as defined in ITU-T H.323), the procedures described above can also be used to inter-work BFCP for user terminals operating in H.323 CS networks.

It can be seen that embodiments of the invention make it possible for CS user terminals and non-BFCP-capable PS user terminals participating in conferences hosted in a PS network, such as the IMS, to perform floor control operations. BFCP-capable terminals can also participate in non-BFCP floor controlled conferences.

1. A method of enabling a user terminal to participate in floor control operations in a telecommunications conference operating a Binary Floor Control Protocol BFCP, the method comprising the steps of:
sending a first message from the user terminal to a gateway node, wherein the first message comprises information relating to floor control operations in the conference;
inter-working the first message received at the gateway node to generate a corresponding BFCP message; and
forwarding the BFCP message to a Floor Control function.

2. A method according to claim 1, wherein the first message is a Dual Tone Multi Frequency DTMF message.

3. A method according to claim 1, wherein the first message is one of a set of messages relating to floor control operations.

4. A method according to claim 3, wherein the set of messages comprises a Floor Request message and a Floor Release message.

5. A method according to claim 1, further comprising, prior to said step of sending a first message, sending a request from said user terminal to said gateway node indicating a desire to participate in Floor Control operations.

6. A method according to claim 5, further comprising sending a reply to said user terminal in response to said request, the reply including a menu of options for requesting floor control operations.

7. A method according to claim 6, wherein the reply comprises an Announcement.

8. A method according to claim 1, further comprising sending a response to the first message to the gateway node, the response comprising either a BFCP Floor Request Status message or an Error message.

9. A method according to claim 8, wherein the Floor Request Status message includes an indication either that the floor request is pending, that it has been granted, or that it has been denied.

10. A method according to claim 8, further comprising inter-working the response to generate an announcement and sending the announcement to the user terminal.

11. A method according to claim 10, wherein the announcement comprises information indicating that the user has been granted the floor, information indicating that the user has been denied the floor, or information that an error has arisen.

12. A method according to claim 1, wherein the gateway node is a gateway between a circuit-switched CS 3G-324M network and an IMS network, and the first message comprises a H.245 control protocol conference indication.

13. A method according to claim 12, wherein the first message comprises a H.245 RequestForFloor conference indication.

14. A method according to claim 13, wherein the step of inter-working the first message comprises generating a BFCP FloorRequest message.

15. A method according to claim 14, further comprising sending a BFCP FloorRequestStatus message from the Floor Control function to the gateway node.

16. A method according to claim 15, wherein the FloorRequestStatus message has a status “granted” when the floor has been granted to the user.

17. A method according to claim 16, wherein the floor requested includes video media, wherein the gateway node sends a H.245 seenByAtLeastOneOther conference indication to the 3G-324M terminal.

18. A method according to claim 12, wherein the floor is an audio conference floor, wherein the gateway node using uses voice activity detection to determine when the user has finished speaking, to generate a BFCP FloorRelease message, and to send the BFCP FloorRelease message to the Floor Control function after the user has finished.

19. A method according to claim 1, wherein the BFCP messages that are inter-worked include one or more of FloorRequest, FloorRelease, FloorRequestStatus and Error messages.

20. (canceled)

21. A method for a user terminal to participate in floor control operations in a telecommunications conference provided by a circuit-switched CS network, wherein the user terminal provides floor control signalling using a Binary Floor Control Protocol BFCP, the method comprising:
sending a first BFCP message from the user terminal to a gateway node, wherein the first BFCP message comprises information relating to floor control operations in the conference;
inter-working the first BFCP message received at the gateway node to generate a corresponding floor control message; and, forwarding the floor control message to the CS network.

22. A system for enabling a user terminal to participate in floor control operations in a telecommunications conference operating a Binary Floor Control Protocol BFCP, the system comprising a gateway node and a Floor Control Server (FCS), wherein the gateway node is configured to receive a first message from a user terminal, the first message comprising information relating to floor control operations in the conference, to inter-work the first message so as to generate a corresponding BFCP message, and to forward the BFCP message to the floor control server.

23. A system according to claim 22, wherein the gateway node comprises a gateway between a circuit-switched and a packet-switched network.

24. A system according to claim 23, wherein the gateway node comprises a Media Gateway Control Function MGCF.

25. A system according to claim 23, wherein the gateway node comprises a Media Gateway MGW and a Media Gateway Controller MGC.

26. A system according to claim 24, wherein the gateway node comprises an IMS Media Gateway M-MGW.

27. A system according to claim 22, wherein the FCS is located in a Media Resource Function Processor MRFP or in an Application Server AS.

28. A gateway function controlling a gateway that provides an interface between a circuit-switched CS network and a packet-switched PS network, the gateway function comprising:
means for receiving a floor control request message from a user terminal, the floor control request message comprising information relating to a conference operating a Binary Floor Control Protocol BFCP;
means for inter-working the floor control request message received at the gateway function to generate a corresponding BFCP message; and
means for forwarding the BFCP message to a Floor Control function in the PS network.

29. A gateway function according to claim 28, wherein the floor control request message is a DTMF message.

30. A gateway function according to claim 28, wherein the floor control request message comprises a H.245 conference indication.

31. A gateway function according to claim 28, wherein the gateway comprises a Media Gateway Control Function MGCF.

32. A gateway function according to claim 28, wherein the gateway comprises a Media Gateway MGW and a Media Gateway Controller MGC.

33. A gateway function according to claim 28, wherein the gateway comprises an IMS Media Gateway IM-MGW.

34. A gateway function controlling a gateway that provides an interface between a circuit switched CS network and a packet switched PS network, the gateway function comprising:
means for receiving a Binary Floor Control Protocol BFCP message from a user terminal, the BFCP message comprising information relating to floor control operations in a conference session provided by the CS network;
means for inter-working the BFCP message so as to generate a corresponding floor control message; and,
means for forwarding the corresponding floor control message to the CS network.
